(19) United States
(12) Patent Application Publication
(10) Pub. No.: US 2015/0323933 A1
(43) Pub. Date: Nov. 12, 2015

(54) OPTIMIZATION OF THE TRAJECTORY OF AN AIRCRAFT

(71) Applicant: THALES, Courbevoie (FR)

(72) Inventors: Alexandre DARBOIS, TOULOUSE (FR); Mathieu LE MERRER, TOULOUSE (FR); Johan BOYER, TOULOUSE (FR)

(21) Appl. No.: 14/707,946

(22) Filed: May 8, 2015

(30) Foreign Application Priority Data
May 9, 2014 (FR) 1401045

(51) Int. Cl. G05D 1/02

(52) U.S. Cl. CPC G05D 1/0202

(57) ABSTRACT

A method implemented by computer for optimizing the cruising trajectory of an aircraft comprises the steps consisting in receiving the parameters of a reference trajectory, the trajectory comprising one or more plateaus and the transitions between these plateaus, the transitions being ascending or descending; and determining, in response to a request received in the course of the flight, at least one candidate alternative trajectory; and determining one or more indicators associated with the candidate alternative trajectory such as determined. Developments comprise the optional display of at least one indicator, indicators associated with the fuel consumption, with a difference in flight time or with the operational cost of the flight of the aircraft, the use of ratios of indicators, the inhibition of descending transitions, particular plateau length transitions as well as economical modes of transition. System aspects are described, comprising avionic or non-avionic means.

### CROSS-REFERENCE TO RELATED APPLICATION

This application claims priority to foreign French patent application No. FR 1401045, filed on May 9, 2014, the disclosure of which is incorporated by reference in its entirety.

### FIELD OF THE INVENTION

The invention relates to the optimization of the flight trajectory of an aircraft, and discloses in particular methods and systems for reducing certain operational flight costs and in particular for making fuel savings.

### BACKGROUND

The trajectory or the flight profile of an aircraft is defined globally before takeoff and adapted during the flight proper (for example as a function of the pilot's actions, themselves possibly prompted by directives from air traffic control or else meteorological changes).

Airlines and the regulator are currently seeking to decrease the impact of aeroplanes on the environment (decrease in waste from CO2 and NOx) and as a corollary to optimize fuel consumption (decrease in the quantity of kerosene) while complying with the constraints of constantly increasing traffic.

The patent literature deals with reducing operational costs, assessed in a general manner. For example, document U.S. Pat. No. 5,574,647 discloses an apparatus and a scheme for determining optimal authorized flight altitudes and the flight points at which to change altitude so as to minimize the cost of the flight while, however, forestalling excessive changes of altitude. This approach presents limitations. The patent literature mentions fuel savings only incidentally. For example, application EP2498159 notes that low engine powers in the airport approach phase reduces fuel consumption. This reduction is not sought per se. Patent U.S. Pat. No. 8,527,119 considers this optimization of the fuel consumption parameter from among numerous other parameters, i.e. does not individually tailor the optimization and is limited to the context of the takeoff of the aeroplane.

The present invention discloses several embodiments presenting numerous advantages in relation to the aspects mentioned hereinabove.

### SUMMARY OF THE INVENTION

There is disclosed a method implemented by computer for optimizing the cruising trajectory of an aircraft comprising the steps consisting in receiving the parameters of a reference trajectory, the said trajectory comprising one or more plateaus and the transitions between these plateaus, the said transitions being ascending or descending; determining, in response to a request received in the course of the flight (or in a phase of preparing this same flight), at least one candidate alternative trajectory; and determining one or more indicators associated with the candidate alternative trajectory such as determined.

The invention relates to the cruising regime of an aircraft. The invention a priori does not apply to the takeoff and landing phases. A request aimed at determining a candidate alternative trajectory is generally received in the course of the flight. It is implicit that the request may be received during flight preparation (initialization). The result of the computation method applies during the cruising phase, but the method in itself can be used in the flight preparation phase.

The reference trajectory is generally the active trajectory (“in progress”), for example such as defined in or by the Flight Management System (FMS). Initially, the trajectory may be the trajectory such as defined by the aircraft flight plan, and may for example comprise plateaus and transitions between these plateaus (the flight plan is prepared on the ground before takeoff and is then continually adapted during the real flight).

The parameters of a trajectory comprise one or more plateaus, as well as one or more transitions between these various plateaus.

In practice, generally at any moment in the course of the flight, the pilot may get proposals for alternative trajectories, e.g. acceptable routes (which comply with the known constraints regarding the weather, ATC, etc), arising from the FMS and/or approved by him. The proposed alternative trajectories are therefore different combinations of plateaus and of transitions between plateaus. At certain moments, as a function of outside events, at regular intervals or in response to a pilot request, the pilot is presented with the gain or the loss (“cost”) associated with each proposed alternative (or with each acceptable transition) for example by means of the displaying of indicators (e.g. gains or losses in terms of time and/or fuel). The pilot may (or may not) actually carry out the proposed alternative trajectory.

The prior art does not present any choice between such candidate trajectories (e.g. possibilities of changes of flight level, longer or shorter plateaus, etc). Generally, in existing avionic systems, the display is limited to that of the “next” transition (e.g. within the planned trajectory of the flight plan) and, moreover, a fortiori, there is no display of indicators associated with these candidate trajectories.

The candidate solutions are by definition limited to the solutions that are “acceptable” from the point of view of aerial navigation. Stated otherwise, the candidate flight profiles are subjected to the ATC for validation once the computation has been performed. The candidate alternative trajectories are “authorized”. Implicitly constraints in formulating the aircraft trajectory are therefore taken into account. These constraints comprise for example the authorized flight levels, constraints of minimum or maximum speed, changes of levels imposed, etc. Stated otherwise, the trajectory parameters are associated with “constraints” (e.g. conditional filters and/or tests, etc).

At least one candidate trajectory is determined. The candidate trajectory may moreover correspond at every point to the initially planned trajectory. In the case where several trajectories are determined, one or more indicators associated with the trajectories can also be determined. These indicators will optionally be displayed (in the case of a drone, it is not necessary to undertake actual display). Each candidate trajectory can give rise to the display of associated indicators, but it is also possible for certain candidate trajectories to be equivalent (e.g. with zero or equivalent gain or loss) and it may happen that the indicators remain stable and/or do not need to be repeated. Generally, one or more candidate trajectories can be associated with one or more indicators.

In a development, the method furthermore comprises a step consisting in displaying at least one indicator.

This embodiment does not relate to autonomous drones, which can nonetheless make use of the intermediate results computed for the same purposes (flight range ensuing from the fuel savings made), or else the realization of other objectives.

In a development, an indicator is associated with the fuel consumption of the aircraft.

The indicator can be in particular associated with the fuel consumption of the aircraft (“delta fuel”).

In one embodiment, the indicator or indicators can be associated with the difference (or with the “disparity” or with the “delta”) of fuel consumption between the candidate trajectory computed under constraints (e.g. ATC, weather) and the reference trajectory (“global” indicator).

In one embodiment, the indicators can be associated with the difference (or with the “disparity” or with the “delta”) of fuel consumption between the candidate trajectory computed under constraints and the candidate trajectory cropped of one or more changes of level (“local” indicator).

In one embodiment, the indicators can be associated with the difference in fuel consumption between the candidate trajectory computed under constraints and the unconstrained optimal trajectory, if applicable (“global” indicator).

The indicators are displayed to the pilot and constitute a first criterion for validating or modifying, as appropriate, the vertical profile followed by the aircraft. Be it so-called “global” or “local”, an indicator is valid for the whole of the vertical profile remaining to be traversed. In certain embodiments, it informs the pilot of the possible loss or the saving of fuel.

In one embodiment, one or more plateaus remaining to be traversed can be associated with individually tailored fuel consumption gains. For example, the pilot might optionally note that a short-term gain in fuel could be nullified by longer-term losses (presence of cloud masses). This embodiment makes it possible for the uncertainties in the underlying computation model to be exhibited to the pilot. In particular, the probabilities or confidence interval associated with each flight section or segment may be communicated to the pilot, directly or indirectly, on demand or by default.

In a development, an indicator is associated with a difference in flight time of the aircraft.

A temporal indicator is aimed at informing the pilot of the gain or of the possible loss of time.

In one embodiment, the difference in flight time relates to the difference between the time associated with the candidate alternative trajectory and the time associated with the reference trajectory (global indicator).

In one embodiment, the difference in flight time relates to the difference between the time associated with the candidate alternative trajectory and the time associated with the candidate trajectory cropped of one or more changes of level (local indicator).

In one embodiment, the difference in flight time relates to the difference between the time associated with the candidate alternative trajectory and the time associated with the unconstrained optimal trajectory, if applicable (global indicator).

In the manner of the previous indicator of fuel consumption, the temporal indicator can be individually tailored by segments and/or associated with confidence values.

In one embodiment, two indicators can be provided to the pilot: a first indicator relating to the flight time and a second indicator to the fuel consumption (these indicators being associated with one—or each—candidate alternative trajectory). In another embodiment, a single indicator is constructed and summarizes or synthesizes the aircraft flight time and fuel consumption indicators.

In a development, an indicator is associated with the operational cost of the flight of the aircraft.

The pilot can only reasonably follow a small number of indicators.

In a particular embodiment, the pilot monitors or trusts a single indicator which (for example) synthesizes the two predominant parameters, namely time and fuel consumption. Stated otherwise, in a particular embodiment, a “complex”- and optionally reductive—synthetic indicator can be proposed so as to lighten the pilot's cognitive burden. Such an indicator can alternatively “summarize” the set of time and/or fuel indicators and also integrate other aspects or parameters of the flight.

The optimization of the flight plan may indeed culminate in diminished loads of the mechanical elements of the engines and thereby lead directly or indirectly to maintenance savings. The set of these parameters can be encompassed in a so-called “operational” cost of the flight (which may therefore comprise fuel costs, economic gains e.g. the non-losses associated with the on-time arrival of the aircraft, the indirect gains in terms of maintenance costs, salaries, bonuses, etc).

In this embodiment, the pilot manages only one single synthetic optimization criterion. This embodiment is advantageous since it masks the underlying complexity from the pilot, who can then concentrate on the operational results of the flight (piloting by results).

In a development, the method furthermore comprises a step consisting in receiving the selection of a ratio of one or more indicators.

The indicators associated with the various options (or candidates alternative routes or trajectories) being determined, the pilot can make a choice between these various options, and also modulate or adapt an option (as appropriate). For example, for a given alternative trajectory, the pilot can “exchange” (or trade or balance or transfer or swap or compensate) gains in time with—or to—mgains in fuel, and vice versa.

In a general manner, the relation between flight time and fuel consumption is a complex relation. The impact of a modification of the altitude profile on these two factors may be agonistic (for example if the wind surfed decreases the flight time and the fuel consumption) or antagonistic (the impact of the temperature is more complex). The impact of a modification of the speed profile on these two factors tends to be antagonistic.

To simplify, the fuel and time indicators are correlated or covariant (i.e. they are partially interdependent) but there is not necessarily—a priori—any simple analytical relation between these two factors (enabling them to be likened). The complex relation between time factor and fuel factor can nonetheless be measured or estimated or computed or simulated (for example in an approximate manner e.g. analytical or via an algorithmic expression).

If in certain embodiments, the fuel consumption and time indicators gain by being “decoupled”, that is to say considered and treated independently of one another, in other embodiments, it is possible to consider them jointly.

Specifically, in another embodiment, the fuel consumption and time indicators can be considered to be covariant and the method can determine or quantify this covariance. The method can then (optionally) comprise a step allowing the pilot to exchange (or trade or balance or transfer or swap or compensate) gains in time with—or to—gains in fuel and vice versa. For example, if the pilot favours punctuality to the detriment of fuel consumption (i.e. the arrival time at destination), he can signal this decision or intention to the method or system according to the invention, (for example by means of cursors or thumbwheels or a suitable for example touch-sensitive man-machine graphical interface), i.e. that he desires to assign the possible gains of a candidate alternative trajectory exclusively to the gain of the journey time. Or conversely, the pilot may favour fuel savings, to the detriment of punctuality or of arrival time at destination. More generally, in the intermediate states, the pilot may select a compromise or an arbitration between gains in terms of time and gains in terms of fuel: he can choose an assignment ratio of “gain in time” to “gain in fuel” (for example in a discrete manner, e.g. 70%/30% or so as to comply with a temporal constraint on his flight plan, RTA for Required Time of Arrival).

Generally, these compromises or arbitrations (or desires, i.e. indications of objectives) can be performed on the basis of two indicators (e.g. time and fuel) or on the basis of a greater number of indicators (three or more).

In a development, the step consisting in determining a candidate alternative trajectory comprising a step consisting in inhibiting the descending transitions.

By default, in the exploration of possibles (mathematical search space), the algorithms defining the vertical flight profile attempt to favour the upward profiles. This rule may or may not be configurable by the user. In one embodiment, the pilot and/or the airline activates or deactivates this predefined rule. In one embodiment, this rule is specified in the “Airline Modifiable Information” (AMI) or “Company Modifiable Information” (CMI). Inhibiting signifies minimizing (or indeed prohibiting) the number of descending transitions in the candidate alternative trajectory.

In a development, the step consisting in determining a candidate alternative trajectory comprising a step consisting in favouring a transition to a plateau if the length associated with the said plateau is longer than a predefined threshold.

In a development, the method furthermore comprises a step consisting in receiving an indication of selection of a candidate alternative trajectory.

In a development, the method furthermore comprises the realization by the aeroplane of the selected candidate alternative trajectory.

In a development, the method furthermore comprises the realization of a transition between plateaus of the selected trajectory, the said transition being performed according to a predefined mode.

According to the state of the art, that is to say according to current aeronautical practice, the transitions between plateaus are performed according to standard engine powers (generally at the maximum of the engine capacities recommended during this flight phase, the principle being to perform the manoeuvres as rapidly as possible).

In reality, the invention teaches that substantial fuel savings can stem from transitions performed according to different modalities. The realization of one or more (or indeed of all) economical climb transitions (“steps”) according to the invention is performed according to a “predefined mode” chosen from among:
a climb with fixed engine command parameter (N1 or EPR or the like) below the climb engine power N1 climb customarily used, determined in terms of absolute value (e.g. N1=82%) while verifying that this value is compatible with the other constraints (N1 min, N1 max, performance of the aeroplane, safety margins, etc);
a climb with variable engine command parameter (N1 or EPR or the like), determined in terms of relative value (e.g. N1=N1 equilibrium+73%×(N1 climb−N1 equilibrium) defined with respect, on the one hand, to the command parameter allowing altitude and speed to be maintained, and, on the other hand, to the extremum command parameter N1 climb, guaranteeing compliance with some of the constraints partially stated hereinabove;
a climb according to a directive in terms of vertical speed (V/S for Vertical Speed) or in terms of tracking of ground slope (FPA for Flight Path Angle), the said directive being fixed by the pilot and the benefit of which is to invoke an engine power below the climb engine power N1 climb customarily used;
a climb determined by a length of change of level, fixed by the pilot, a safe engine power directive stemming from the said length. This is so while guaranteeing that the transition length fixed by the pilot is larger than the length carried out with the climb engine power N1 climb customarily used.

The various modalities of transition between plateaus may be—in themselves—associated with gains (i.e. savings) of fuel. The association is theoretical and/or practical. Theoretical models may for example make it possible to simulate and therefore to estimate the fuel consumption associated with each mode of transition, and therefore the differential advantage in following such and such a mode of transition. During the display (optional) of the indicators of gains or losses in fuel, the values of relative gains that are associated with the various proposed transitions can be individually tailored or totalled and exhibited (i.e. displayed) to the pilot.

All or some of the transitions may be performed according to these “economical” predefined modes. For example, an airline can “constrain” (barring exceptions for traffic related ATC constraints or emergency manoeuvres) to particular modes of transition (savings, passenger comfort, etc). In other cases, the pilot will be able to choose according to his own preferences, the circumstances of the moment, etc. At each occurrence of a candidate transition, indications of potential gains (e.g. unitary or aggregated) can therefore be displayed to the pilot (or in the flight deck off-board a drone for example).

There is disclosed a computer program product, comprising code instructions making it possible to perform one or more of the steps of the method, when the said program is executed on a computer. There is disclosed a system comprising means for implementing one or more steps of the method, notably avionic means of Flight Management System type and/or non-avionic means of Electronic Flight Bag type.

Advantageously, the methods and systems described allow substantial economical gains, in particular for the optimization of an aeroplane's flight cost.

The cost of a flight comprises several main factors, which are to do with fuel consumption, flight time and engine wear. These factors are influenced by a great variety of outside disturbances, which are of varied natures (meteorological conditions, ATC air traffic directives, etc). Any minimization of this cost is done in strict compliance with air safety rules.

Advantageously, the methods and systems described make it possible to optimize the cruising regime of an aircraft (during the flight profile or the trajectory), to reduce fuel consumption as well as the associated ecological footprint (emissions of CO2 and NOx). On the scale of an in-flight trajectory, the cruising phase accounts for most of the fuel consumed. This phase constitutes, in this regard, a particularly favourable lever for fuel savings.

More precisely, the gains in relation to fuel savings are made not only during plateaus but also during changes of flight level (transient phases), this having been revealed by dedicated measurements and experiments. Stated otherwise, the present invention teaches optimizations of the trajectory of the aircraft, notably during the transient phases between plateaus, which can culminate in substantial fuel savings.

Advantageously, the maintenance costs can also be optimized indirectly. For example, lesser mechanical loads associated with an optimized trajectory of the aircraft can appreciably decrease the necessity for (and therefore the cost of) maintenance operations after flights.

Advantageously, the methods and systems described are simple to use (e.g. display of synthetic indicators such as fuel and time deltas), are flexible (e.g. possibility of modifying the flight profile in the course of a mission) and are by construction compatible with the avionic systems of FMS type (“Flight Management System” or flight computer).

Advantageously, the method described makes it possible to display data that are generally reliable as regards the deltas (disparities in gain or loss) announced (fuel, time and others).

Advantageously, the method described is robust to large variabilities in meteorological conditions.

Advantageously, the method described can be embedded onboard or implemented in an existing (“retro fit”) or forthcoming (“forward fit”) FMS.

The present invention will advantageously be implemented in all avionic environments, including in relation to remotely-piloted or autonomous drones (certain of which uses may require prolonged flights).

### BRIEF DESCRIPTION OF THE FIGURES

Various aspects and advantages of the invention will be apparent in support of the description of a preferred but nonlimiting mode of implementation of the invention, with reference to the figures hereinbelow:

FIG. 1 illustrates the global technical environment of the invention;

FIG. 2 schematically illustrates the structure and the functions of a flight management system of known FMS type;

FIG. 3 illustrates an exemplary flight trajectory of the aircraft and shows various examples of transitions between plateaus;

FIG. 4 details certain examples of steps of the method according to the invention.

### DETAILED DESCRIPTION

Certain technical terms and environments are defined hereinafter.

The acronym, or initials, EFB corresponds to the conventional terminology “Electronic Flight Bag” and designates onboard electronic libraries. An EFB is a portable electronic apparatus used by the flight personnel (for example pilots, maintenance, deck etc.). An EFB can provide the crew with flight information aiding them to perform tasks (with less paper). In practice, it generally entails an off-the-shelf computing tablet. One or more applications allow the management of the information in respect of flight management tasks. These computing facilities for general use are intended to reduce or replace the reference material in paper form, often found in the hand luggage of the “Pilot Flight Bag” and which may be tiresome to handle. The paper reference documentation generally comprises the piloting manuals, the various navigation maps and the ground operations manuals. This various documentation is advantageously dematerialized in an EFB. Furthermore, an EFB can host software applications specially designed to automate operations conducted manually in normal time, such as for example the takeoff performance computations (computation of limit speed, etc).

Various classes of EFB material exist. Class-1 EFBs are portable electronic apparatuses (PED), which are not normally used during takeoff and during disembarkation operations. This class of apparatus does not require an administrative process for particular certification or authorization. Class-2 EFB apparatuses are normally disposed in the cockpit, e.g. mounted in a position where they are used in all the flight phases. This class of apparatuses requires prior authorization of use. Class-1 and class-2 apparatuses are considered to be portable electronic apparatuses. Fixed installations of class 3, such as computer media or fixed docking stations installed in aircraft cockpits generally demand approval and certification on the part of the regulator.

The acronym, or initials, FMS corresponds to the conventional terminology “Flight Management System” and designates the flight management systems of aircraft. During flight preparation or during rerouting, the crew undertakes the inputting of various information relating to the progress of the flight, typically by using an FMS aircraft flight management device. An FMS comprises input means and display means, as well as computation means. Via the input means, an operator, for example the pilot or the copilot, can input information such as RTAs, or “waypoints”, associated with routing points, that is to say points vertically in line with which the aircraft must pass. The computation means make it possible notably to compute, on the basis of the flight plan comprising the list of waypoints, the trajectory of the aircraft, as a function of the geometry between the waypoints and/or of the altitude and speed conditions.

The acronym MMI corresponds to Man-Machine Interface (or equivalently, HMI, Human Machine Interface). The input of the information, and the display of the information input or computed by the display means, constitute such a man-machine interface. With known devices of FMS type, when the operator inputs a routing point, he does so via a dedicated display displayed by the display means. This display may optionally also display information relating to the temporal situation of the aircraft in relation to the routing point considered. The operator can then input and view a time constraint prescribed for this routing point. Generally, the MMI means allow the inputting and consultation of the flight plan information, piloting data, etc.

The pilot of an aircraft or aeroplane uses the flight plan information in several contexts: within the avionic equipment by means of the FMS (Flight Management System) and/or by means of an “EFB” (Electronic Flight Bag), for example of tablet type. In current avionic systems, the flight plan is generally prepared on the ground by the mission preparation technician, for example by using a tool called “Flight Planning System”. A part of the flight plan is transmitted to the air traffic control for validation. The flight plan is ultimately entered into the FMS.

A “transition” (or “step”) corresponds to a change of flight levels (FL for “Flight Level”). The flight levels are discrete and those which are authorized for cruising are imposed by the aerial navigation control. The flight levels are measured in multiples of 100 feet. Conventionally, the flight levels authorized at high altitude are multiples of 1000, 2000 or 4000 feet (ft). For example in certain zones, the odd flight levels (29,000 feet/FL290, 31,000 feet/FL310, etc) are authorized without the West-to-East sense and the even flight levels (30,000 ft/FL300, 32,000 ft/FL320, etc) are authorized in the East-to-West sense.

A “route” comprises in particular a list of non-georeferenced identifiers making it possible to describe the trajectory of the aircraft.

A “flight plan” comprises notably a list of georeferenced objects associated with the identifiers of the route. A flight plan can generally be represented graphically by a succession (not necessarily continuous) of “segments” (or “flight portions” or “trajectory elements”).

A “trajectory” is generally defined as a continuous path described in 3 or more dimensions (spatial dimensions as regards positions, but also speeds, time, mass, etc.), corresponding to a set of data describing the evolution of a plurality of physical parameters of the aeroplane, as well as their dynamics in regard to or as a function of the flight plan.

The “reference trajectory” corresponds in particular to the initially computed trajectory. The “active trajectory” is that to which the aeroplane is slaved. A “candidate trajectory” arises from an optimization, for example determined according to the invention, e.g. optionally computed under constraints, but which is not yet activated. The “optimal trajectory” arises from an optimization without any constraint.

A vertical flight profile corresponds to the projection in terms of altitude onto a vertical plane of the trajectory as defined hereinabove.

A plateau is a trajectory portion (or segment) carried out (i.e. flown) at (substantially) constant altitude.

A “change of flight level” (or “transition” or “transition between plateaus” or “step”) is a trajectory portion describing the change of a plateau carried out at a given flight level to the next (e.g. which may be above or below the current or present flight level).

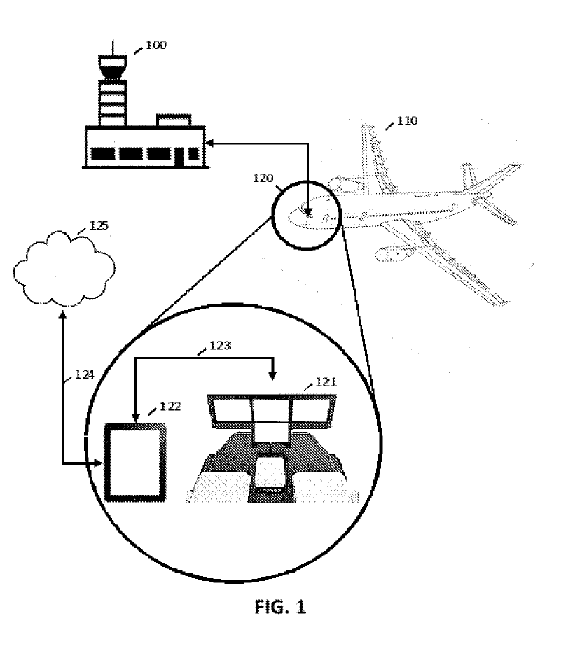

FIG. 1 illustrates the global technical environment of the invention. Avionic equipment or airport means 100 (for example a control tower linked up with the air traffic control systems) are in communication with an aircraft 110. An aircraft is a means of transport capable of moving around within the terrestrial atmosphere. For example, an aircraft can be an aeroplane or a helicopter (or else a drone). The aircraft comprises a flight deck or a cockpit 120. Situated within the cockpit is piloting equipment 121 (termed avionic equipment), comprising for example one or more onboard computers (means of computing, saving and storing data), including an FMS, means of displaying or viewing and inputting data, communication means, as well as (optionally) haptic feedback means. An EFB 122 may be situated aboard, in a portable manner or integrated into the cockpit. The said EFB can interact (bilateral communication 123) with the avionic equipment 121. The EFB can also be in communication 124 with external computing resources, accessible through the network (for example cloud computing 125). In particular, the computations can be performed locally on the EFB or partially or totally in the computation means accessible through the network. The onboard equipment 121 is generally certified and regulated while the EFB 122 and the connected computing means 125 are generally not (or to a lesser extent). This architecture makes it possible to inject flexibility on the EFB 122 side while being ensured of controlled safety on the onboard avionics 121 side.

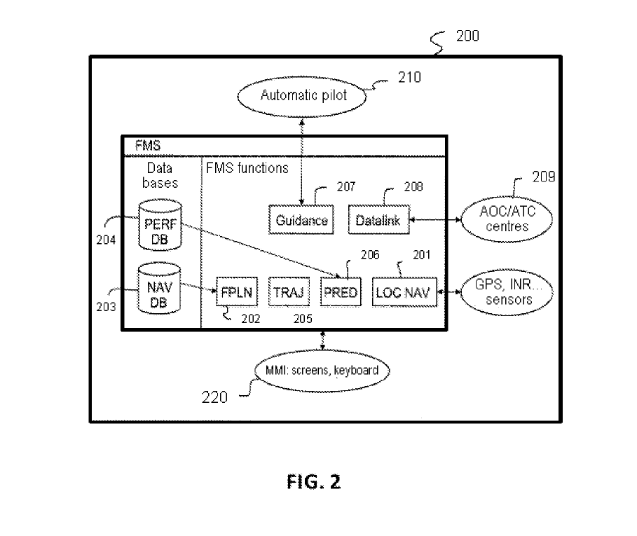

FIG. 2 schematically illustrates the structure and the functions of a flight management system of known FMS type. A system of FMS type 200 disposed in the cockpit 120 and the avionic means 121 has a man-machine interface 220 comprising input means, for example formed by a keyboard, and display means, for example formed by a display screen, or else simply a touch-sensitive display screen, as well as at least the following functions:
Navigation (LOCNAV) 201, for performing the optimal location of the aircraft as a function of the geolocation means 230 such as satellite-based or GPS, GALILEO geo-positioning, VHF radionavigation beacons, inertial platforms. This module communicates with the aforementioned geolocation devices;
Flight plan (FPLN) 202, for inputting the geographical elements constituting the “skeleton” of the route to be followed, such as the points imposed by the departure and arrival procedures, the routing points, the air corridors (or “airways” as they are commonly known). The methods and systems described affect or relate to this part of the computer;
Navigation database (NAVDB) 203, for constructing geographical routes and procedures with the help of data included in the bases relating to the points, beacons, interception legs or altitude legs, etc;
Performance database, (PERFDB) 204, containing the craft's aerodynamic and engine parameters;
Lateral trajectory (TRAJ) 205, for constructing a continuous trajectory on the basis of the points of the flight plan, complying with the performance of the aircraft and the confinement constraints (RNP);
Predictions (PRED) 206, for constructing an optimized vertical profile on the lateral and vertical trajectory and giving the estimations of distance, time, altitude, speed, fuel and wind notably at each point, at each change of piloting parameter and at destination, which will be displayed to the crew. The methods and systems described affect or relate mainly to this part of the computer;
Guidance (GUID) 207, for guiding in the lateral and vertical planes the aircraft on its three-dimensional trajectory, while optimizing its speed, with the aid of the information computed by the Predictions function 206. In an aircraft equipped with an automatic piloting device 210, the latter can exchange information with the guidance module 207;
Digital data link (DATALINK) 208 for exchanging flight information between the Flight plan/Predictions functions and the control centres or the various other aircraft 209;
one or more screens, notably the so-called FMD, ND and VD screens.

The FMD (“Flight Management Display”) is an interface, generally a display screen, which may be interactive (for example a touch-sensitive screen), making it possible to interact with the FMS (Flight Management System). For example, it makes it possible to define a route and to trigger the computation of the flight plan and of the associated trajectory. It also makes it possible to consult the result of the computation in text form.

The ND (“Navigation Display”) is an interface, generally a display screen, which may be interactive (for example a touch-sensitive screen), making it possible to consult in two dimensions the lateral trajectory of the aeroplane, viewed from above. Various modes of viewing are available (rose, plane, arc, etc) as well as according to various scales (configurable).

The VD (“Vertical Display”) is an interface, generally a display screen, which may be interactive (for example a touch-sensitive screen), making it possible to consult in two dimensions the vertical profile, projection of the trajectory. Just as for the ND, various scales are possible.

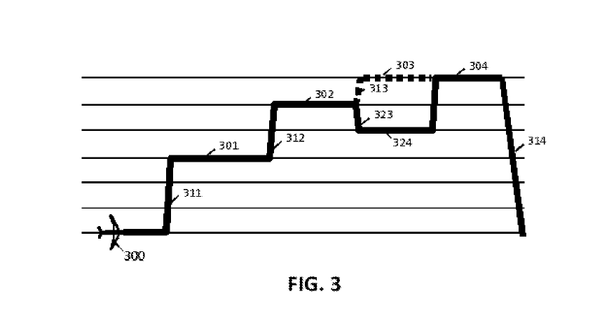

FIG. 3 illustrates the vertical profile of a flight plan. The profile comprises a succession of plateaus (301, 302, 303 or 324, 304) and transitions, also called changes of flight levels. After takeoff 311, the aeroplane or aircraft 300 stabilizes at a level or plateau 301. In the course of cruising, for example subsequent to the receipt of a directive emanating from the air traffic control or else of the notification of the presence on the route of a cloud mass with headwinds, the aeroplane may be required to change flight level. For example, the aeroplane may be required to follow an ascending transition 313 to reach a plateau 303. Alternatively the aeroplane may follow a descending transition 323, to stabilize at a level 324 (to subsequently climb back to a level 304 thereafter).

The computation of the flight profile generally gives preference to ascending profiles, that is to say favouring the ascending transitions. This type of profile is represented by the dotted flight level 303. Generally and for equivalent meteorological conditions, the more the mass decreases, the more beneficial it is for the aeroplane to gain some attitude in order to reduce fuel consumption. Conversely, lower altitudes generally signify increased fuel consumptions. Outside of strictly technical causes, pilots generally prefer to pick up altitude as rapidly as possible, in view of the possible limitations emanating from air traffic control (which may lead an aircraft to remain “blocked” at a certain “disadvantageous” level or plateau). The schemes for computing the initial flight profiles, or recomputations of these same profiles, therefore tend to favour the exclusively ascending transitions (with the exception of the final descent of the craft towards the airport). In more mathematical terms, the combinatorial optimization is carried out firstly in a search space (space of possibles) comprising solely solutions exhibiting ascending transitions.

There nonetheless exist advantageous exceptions to this type of “all-upward” or “all climbing” profile. Indeed, a descending transition may have a positive impact on fuel consumption. This is notably the case when the atmospheric circulation is such that winds favourable to the journey of the aeroplane can be exploited at lower altitude levels (“surfing the wind”). This type of alternative is generally counter-intuitive to the pilot: the display of corresponding alternative routes on the MMIs is advantageous (all the more as these alternatives are motivated in a graphical manner, that is to say accompanied by the gains in time and in fuel). The present disclosure makes it possible specifically to utilize such changes of level, for fuel saving purposes.

The determination of the transitions may require the consideration of one or more descending transitions.

In one embodiment, relating to the profile computation algorithms which are not necessarily directly detectable on the screen, in the case where a descending transition is envisaged or proposed and/or actually carried out, the computation steps of the method compare the descent with ascending alternatives, as appropriate. Therefore, a descent is actually proposed and/or carried out only if it is actually worth it. Stated otherwise, pilots and their companies are ensured that the algorithmic engine of the method checks to verify the well-foundedness of a transient descent, in view of the knowledge available at the time the method is operative. These computation steps are not necessarily visible according to this embodiment (for example, the steps are masked within the computer of an autonomous drone). They may be so by means of the documentation associated with the corresponding functions, for example the technical or commercial documentation).

In another embodiment, the descending transition considered is displayed for the pilot, accompanied optionally by one or more items of information. This complementary information can in particular aid the pilot in his decision taking as to whether or not to conduct a descent to a lower plateau, an operation which according to case may sometimes turn out to be counter-intuitive. The information provided constitutes so many “motivations”, i.e. justifying an opportunity for adaptation of the flight. For example, the gains in fuel and/or in time on the plateau flown or the proposed trajectory portion may explain to the pilot the factual reasons why the descent is proposed. This embodiment corresponds to an interaction model in which the pilot can progressively (and/or iteratively) go more deeply into aspects of the flight profile computation. In particular, the pilot may consider that the short-term gain in fuel is not sufficient in regard to the global picture that he has of the trajectory. In this case, the pilot corrects the decision aid system (which is by nature necessarily limited). On the contrary, the pilot may grasp the opportunity of the gain presented if his global picture of the journey does not comprise any immediate counter-indications with respect to the proposal displayed.

In one embodiment, the display of just the “fuel” indicator is proposed. This particular mode presents the advantage of simplicity, the criterion associated with the fuel being the critical factor to be mastered.

In another embodiment, the display of just the “time” indicator is proposed. This particular mode corresponds to particular flight policies. For example, an airline may decide to favour the punctuality of its flights, even if to the detriment of fuel consumption.

In another embodiment, the “time” and “fuel” displays are combined. This mode affords the pilot a depth of view.

In one embodiment, a single synthetic indicator is used. This mode presents the advantage of unburdening the pilot, by allowing him to concentrate on other, more critical cognitive tasks. In this embodiment, the indicator is an indicator which globally summarizes the operational cost of the flight. The operational cost of the flight can comprise costs such as fixed costs, costs related to engine wear and/or deformations of mechanical components (engine blades for example), foreseeable maintenance costs. The single indicator can take various forms or expressions. For example, the indicator can be a score between 0 and 100 or between 0 and 1. The indicator in particular can be the display of a monetary value (absolute cost, cost overhead, bonus, etc). The indicator can also be a symbol and/or a colour code and/or a span of discrete or continuous values. The indicator can be static or animated or rendered in the form of video or holograph or sound or vibration (for example of variable and/or configurable intensity).

Generally, the flight profile can be optimized more or less. In a local manner, additional optimizations can be introduced. In particular, the manner of managing the transitions between the flight levels can be devised in such a way as to reduce fuel consumption still more. The prior art knows one and only one completely automated transition “technique”, called “OPEN CLB” which consists in applying the maximum recommended engine thrust during a flight phase of cruising type. In practice, once the decision to change level has been made, the pilot triggers a transition which is performed in an automatic manner and according to an engine power which ignores any fuel consumption consideration. Simulations and experiments have shown that devising the transitions at optimized engine powers brought about benefits equivalent to those observed for the global optimization of the vertical flight profile.

In a particular embodiment, the method furthermore comprises a step consisting in receiving a request (for determining a candidate alternative trajectory) at predefined time intervals. For example, these predefined time intervals may be regular (e.g. periodic) or irregular (e.g. preconfigured alarms). The intervals may be intermittent, etc. Stated otherwise, the repetition of the method may be entirely automatic, or entirely manual, or partially automated.

In a particular embodiment, the method can also comprise recomputations or repeated computations of trajectory whose vertical profile brackets an instantaneous optimal altitude profile “OptFL” according to the FLs (“Flight Levels”) authorized (approved by the ATC), by bracketing the said profile by the so-called rule of “X/(1−X)” in piloting jargon.

In practice, according to an example scenario, in an aircraft flight deck (or else implemented in an autonomous drone modulo a few adaptations), the insertion of a cruising profile can comprise the steps enumerated hereinafter.

After a cruising profile is proposed to the pilot and then selected by him, there is undertaken the selection of the corresponding procedure via a dedicated FMD button or an equivalent on the cruising performance page. The computation of the profile is carried out thereafter and the new transitions (or “steps”), optimized, as well as the associated fuel/time budget are displayed in a graphical and textual manner. At this juncture, it may yet be possible to modify the profile (according to diverse operations). Once it has been definitively selected, the profile is inserted into the active flight plan (or real flight plan, that is to say that which will be followed physically by the aeroplane). Within the FMS, the page FPLN (ACTIVE or TMPY) or an equivalent viewing means makes it possible for example to view the flight plan including the optimized profile.

The proposed solution therefore allows pilots to input the base cruising flight level (CRZ FL) and to input the desired “cost index” (in a manner identical to the Prior art). Moreover, the disclosed solution also makes it possible to a) modify the altitude delta between two levels (ΔFL), b) to select the procedure (FMD page associated with the cruising performance or an equivalent) and c) to insert one (or more) geographical step(s) through the manual input of the altitude or the choice of the WPT (waypoint) through a predefined and intelligent list containing the next waypoints of the active FPLN d) to (re)launch the computation of the optimized profile e) to individually delete one (or more) existing step(s) f) to delete all the optimized steps g) to insert the optimized profile into the temporary flight plan h) to insert the optimized profile into the active flight plan i) to activate for one (or more) step(s) the “soft” option by imposing, if the automatic and optimized computation option is not activated, the value i) either of a reduced thrust level termed “derated” (“D5” for 5% of N1 as less for example) ii) or of the climb distance (“X30” for example for a step of 30NM) iii) or of an FPA iv) or of a vertical speed.

In terms of display on the MMIs, in a particular embodiment the proposed solution makes it possible to display the following information on the FMD: 1) the predictions relating to each step through the distance and the time 2) the difference between the optimized profile (query or temporary) and the active flight plan in terms of fuel and time 3) the fuel and the time of arrival at the destination if the profile is inserted into the active. Conventionally the colour codes may be blue (value modifiable by the crew), yellow (TMPY FPLN), green (ACTIVE FPLN).

The proposed solution makes it possible to display the following information on the ND: 1) the “Start of Climb” indicating the start of an ascending step 2) the “Top of Climb” indicating the end of an ascending step 3) the “Top of Descent” indicating the start of a descending step 4) the “End of Descent” indicating the end of a descending step. Also, 5) the predicted trajectory, vertical (VD) and lateral (ND), may be displayed.

The various steps of the scheme can be implemented in all or part on the FMS and/or on one or more EFBs. In a particular embodiment, all the information is displayed on the screens of the FMS alone. In another embodiment, the information associated with the steps of the scheme are displayed on the or sole onboard EFBs. Finally, in another embodiment, the screens of the FMS and of an EFB can be used jointly in so-called “integrated” fashion, for example by “distributing” the information over the various screens of the various apparatuses, as well as by optionally integrating therewith certain information arising from other systems such as the modes of the automatic pilot for example. A spatial distribution of the information performed in an appropriate manner can contribute to reducing the cognitive burden of the pilot and thereby improve decision taking and increase flight safety.

Additional man-machine interface means can be used. In particular, the man-machine interfaces can, as a supplement to the screens of the FMS and/or of the EFB, be displayed in virtual and/or augmented reality headsets. For example, the means of individual display of the pilot or pilots can comprise an opaque virtual reality headset or a semi-transparent augmented reality headset or a headset with configurable transparency, projectors (pico-projectors or videoprojectors) or else a combination of such apparatuses. An individual display headset can be a virtual reality (VR) headset, or an augmented reality (AR) headset or a high sight, etc. The headset can therefore be a “head-mounted display”, a “wearable computer”, “glasses” or a videoheadset. The information displayed can be entirely virtual (displayed in the individual headset), entirely real (for example projected onto the plane surfaces available in the real environment of the cockpit) or a combination of the two (in part a virtual display superimposed or merged with reality and in part a real display via projectors). The display can also be characterized by the application of predefined rules of emplacement and rules of display. For example, the man-machine interfaces (or the information) are (or is) “distributed” (segmented into distinct portions, optionally partially redundant, and then apportioned) between the various virtual or real screens.

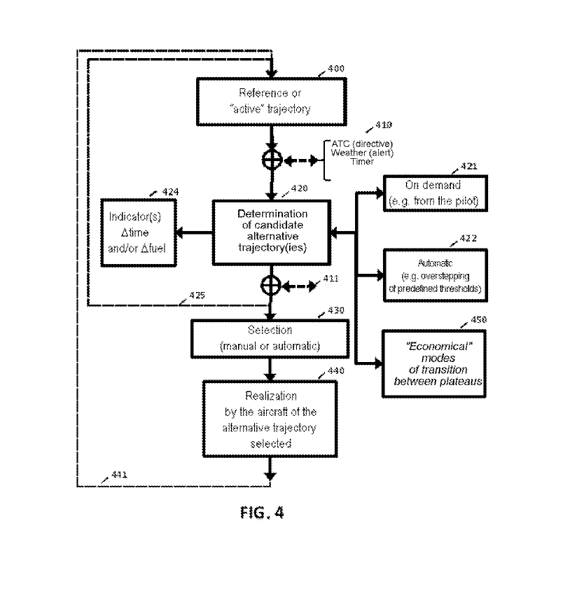

FIG. 4 presents an overall view of the method and examples of steps. On the basis of a reference trajectory 400 (or of a so-called “active” trajectory, that is to say according to the flight plan in the course of realization in accordance with the FMS), the method comprises steps which require the determination 420 of candidate alternative trajectories. An alternative trajectory comprises plateaus and transitions between plateaus, which satisfy the demands of air safety. The agreement (or the consent or the authorization or the “clearance” or the “directive” or the “instruction”) of the ATC (air traffic control) for an alternative trajectory can be provided upstream 410 of the determination 420 (e.g. the alternative trajectories must comply by construction with a set of rules enacted and provided by the ATC) or else be provided downstream 411 (e.g. the various trajectories are determined according to the method of the invention and then filtered or selected by the ATC). The determination of the alternative trajectories can also result from an iterative process, i.e. in interaction with the ATC (cycles of proposal, confirmation/denial, proposal, etc). In one embodiment, a candidate alternative trajectory is authorized and provided via the FMS system. The determination of one or more alternative trajectories can be triggered in various ways. This determination can be performed on demand 421 (for example on request of the pilot) or be performed in an automatic manner 422 (for example upon overstepping predefined thresholds). The triggering of the determination of alternative routes can also stem from a combination of pilot commands and conditions defined (statically or dynamically) by the onboard computer. For example, the receipt of outside events (such as ATC directives and/or weather alerts and/or various zones or other alarms), can also trigger the computation of alternative trajectories. During the determination of candidate alternative trajectories, one or more associated indicators 424 may be determined. These indicators may (or may not) be displayed in a graphical manner. For example, in the case of an autonomous drone there is no necessity for display. In the case of a remotely piloted drone or of a commercial airliner, one or more indicators may be displayed destined for the pilot. In one embodiment, these indicators indicate the gains or losses in regard to arrival time at destination and/or to fuel consumption. In the absence of a manual selection by the pilot or of automatic selection by the system, the previous steps can be repeated 425 (stated otherwise the system continually or regularly or intermittently checks or verifies the active trajectory, the pilot's requests as well as all the outside events such as air traffic directives and meteorological alerts; thereupon, the system continually or regularly or intermittently determines the possible alternative trajectories, that is to say those compatible with the FMS and the aerial navigation constraints). In step 430, an alternative trajectory is selected (for example by the pilot, but automatic selection criteria are also possible). In one embodiment 440, the aircraft carries out the alternative trajectory selected according to the various ones known also of step 420 and optionally selected during step 421 (in a particular embodiment).

Various “economical” modes 450 of transitions between plateaus can be implemented. These transitions can indeed be performed according to different modalities, described previously (“predefined modes”).

On completion of the realization of the transition/plateau, the steps of the method are repeated 441 (i.e. the system updates the flight conditions and proposes new trajectories, as appropriate, etc).

The present invention may be implemented on the basis of hardware and/or software elements. It may be available in the guise of computer program product on a computer readable medium. The medium may be electronic, magnetic, optical or electromagnetic. The computing means or resources may be distributed (“Cloud computing”).

1. A method implemented by computer for optimizing the cruising trajectory of an aircraft comprising the steps:
receiving the parameters of a reference trajectory, the said trajectory comprising one or more plateaus and the transitions between the said plateaus, the said transitions being ascending or descending;
determining, in response to a request received in the course of the flight, at least one candidate alternative trajectory; and
determining one or more indicators associated with the candidate alternative trajectory such as determined;
said determining a candidate alternative trajectory comprising a step consisting in inhibiting the descending transitions.

2. The method according to claim 1, further comprising displaying at least one indicator.

3. The method according to claim 1, an indicator being associated with the fuel consumption of the aircraft.

4. The method according to claim 1, an indicator being associated with the flight time of the aircraft.

5. The method according to claim 1, an indicator being associated with the operational cost of the flight of the aircraft.

6. The method according to claim 1, further comprising receiving the selection of a ratio of one or more indicators.

7. The method according to claim 1, said determining a candidate alternative trajectory comprising a step consisting in favouring a transition to a plateau if the length associated with the said plateau is longer than a predefined threshold.

8. The method according to claim 1, further comprising receiving an indication of selection of a candidate alternative trajectory.

9. The method according to claim 8, further comprising realization by the aeroplane of the selected candidate alternative trajectory.

10. The method according to claim 9, further comprising realization of a transition between plateaus of the selected trajectory, the said transition being performed according to a predefined mode.

11. A computer program product, comprising code instructions making it possible to perform the steps of the method according to claim 1, when the said program is executed on a computer.

12. A system comprising means for implementing one or more steps of the method according to claim 1.

13. The system according to claim 13, comprising avionic means of FMS flight management system type.

14. The system according to claim 12, comprising non-avionic means of electronic flight bag type.
